(19) United States
(12) Patent Application Publication
(10) Pub. No.: US 2011/0171849 A1
(43) Pub. Date: Jul. 14, 2011

(54) DEVICE FOR SECURE ELECTRICAL CONNECTION

(75) Inventor: Mounim Houir Alami, Paris (FR)

(73) Assignee: SOCIETE D'EXPLOITATION DES PROCEDES MARECHAL, Saint-Maurice Cedex (FR)

(21) Appl. No.: 13/001,227

(22) PCT Filed: May 19, 2009
(86) PCT No.: PCT/FR09/00579

§ 371 Date: Feb. 25, 2011

(30) Foreign Application Priority Data
Jun. 25, 2008 (FR) 0803545

(51) Int. Cl. H01R 13/62

(52) U.S. Cl. 439/345

(57) ABSTRACT

The invention relates to an electrical connection device formed of an active base (2) and a plug (1), pilot contacts of a pilot circuit being provided for controlling an apparatus by switching the same on or off, respectively, the power contacts of the base by means of an actuator (10) set up on the base while a device (11, 12; 14), for locking and unlocking the plug into the base in a connection position, is also provided. The device according to the invention is particularly remarkable in that a means (11; 12) for locking the base separately from the actuator (10) is movably mounted, the actuator (10) of the pilot circuit being set up to secure said base locking means in the locked position thereof when said pilot circuit is closed and release the locking means when the pilot circuit is open, while the base locking means prevents all operations for coupling the plug and the base, or for separating the latter once coupled, when said locking means is secured in the locked position thereof by said actuator (10).

The invention relates to a secure electrical connection device, more particularly intended for high power currents.

In a manner known per se, the electrical connection devices comprise an active base and a plug each provided with at least one power contact which are arranged so as to be connected together when the plug and said base are coupled in a connection position.

Connection devices more particularly for high power currents are generally provided with a parallel low power circuit, referred to hereinafter as a pilot circuit, which is provided with pilot contacts arranged to control an apparatus for switching on or switching off the power to the power contact or contacts of the base through the closure and the opening respectively of said circuit.

The aim of this is firstly to ensure that the pilot circuit can only be closed after the connection of the power contacts and in contrast secondly to force the opening of said pilot circuit before the disconnection of the power contacts, such that these two connection and disconnection operations are carried out while the power is off.

It is in fact frequently imperative to bring together or separate the power contacts while the power is off so as in particular to avoid electrical arcs in order to ensure that the power is switched on only when said contacts are in an electrical connection position.

Document EP-0 185 828 describes a connector of this type which additionally comprises an actuator arranged on the base to close and open the pilot circuit, while a device is provided for locking and unlocking the plug in the base in a connection position and comprises matching locking means arranged on the plug and on the base respectively.

However, in this known device for connection by rotation of the power contacts, the actuator which acts directly on the pilot contacts also serves as locking means for the plug and the base.

The invention proposes an electrical connection device provided, as mentioned previously, with a pilot circuit, an actuator and a device for locking and unlocking the plug in the base but which is notably remarkable in that the locking means for the base separate from the actuator is mounted so as to be mobile and has at least one locking position and one unlocking position, the actuator of the pilot circuit being arranged to secure said locking means for the base in its locking position when said pilot circuit is closed, and to release the locking means when the pilot circuit is open, while the locking means for the base prevents any manoeuvre for coupling the plug and the base or separating these once coupled, when said locking means is secured in its locking position by said actuator.

According to one mode of embodiment, the pilot circuit comprises two pilot contacts fixed on the base and a shunt mounted so as to rotate on the base, while the actuator comprises a means which is locked in rotation with the shunt and has at least one position in which the two pilot contacts close the pilot circuit by contact with the shunt and at least one position in which at least one of the pilot contacts is not in contact with the shunt, the pilot circuit then being open.

In this mode of embodiment, the actuator acts on the shunt and not directly on the pilot contacts which are fixed in contrast to the known prior art described in the document EP-0 185 828 mentioned above.

For example, the locking means for the base comprises a hook which can be moved between a locking position and an unlocked position, and which is locked to an actuating button, while the locking means for the plug comprises a groove designed to receive said hook in the locking position obtained at the end of coupling of the plug and the base, while an elastic means is provided to force the hook towards its locking position.

In this case for example, said hook has an appropriate shape to be forced by a portion of the plug in order to enable it to become lodged by elasticity in the groove of said plug without it being necessary to operate the actuating button.

Advantageously, according to one mode of embodiment provided, as specified previously, with a rotary shunt and a locking means in the form of a hook and a button, the means of the actuator locked in rotation to the shunt is a rotary ring which is provided with a skirt passing under a portion of the actuating button of the hook to secure the latter in a locking position while a notch is provided in said skirt to allow the mobility of said actuating button towards the unlocked position of the hook, this notch being formed in a location on the skirt such that said notch is positioned under said actuating button when the ring is in a position in which the pilot circuit is open.

To secure the device again, according to one mode of embodiment, a locking means for the actuator is also provided to secure the latter in its position in which the pilot circuit is open, while said locking means is arranged so as to be entrained into a releasing position by a portion of the plug when the latter is in a connection position, such that the actuator cannot be manoeuvred into its position in which the pilot circuit is closed until after the coupling of the plug in the base and connection of the power contact or contacts of the plug and the base.

For example in this case, the actuator comprises a rotary ring and the locking means for said actuator takes the form of at least one moving rod which is forced by an elastic means towards its locking position in which said rod is introduced into a portion of the actuator to secure said ring in rotation while the rod can be entrained towards its releasing position by a portion of the end of the plug in the course of its coupling with the base. In particular for example, the moving securing rod passes through an opening in the form of an arc of a circle formed in the actuator and has a shoulder designed to fit into a suitable housing of the actuator to secure the latter such that the rod does not impede the rotation of the actuator when the shoulder is outside said housing.

Thus, with the last mode of embodiment mentioned previously, it can be seen that apart from the security features obtained to effect the connection and the disconnection of the power contacts while the power is off, any switching on of the power to the base is prevented as long as the plug is not completely connected.

The invention will be clearly understood on reading the description which follows and which refers to the attached drawings in which:

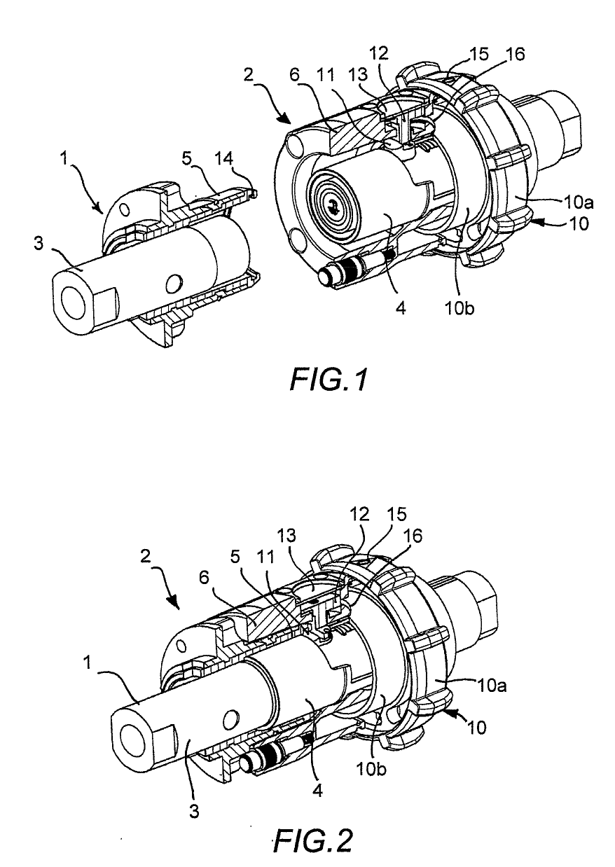

FIG. 1 shows in perspective a base and a plug of a connection device according to one mode of embodiment of the invention, the two elements being shown separately before coupling and connection and with sections of the outer casings of the plug and the base;

FIG. 2 shows the base and the plug in FIG. 1 towards the end of their coupling in a connection position;

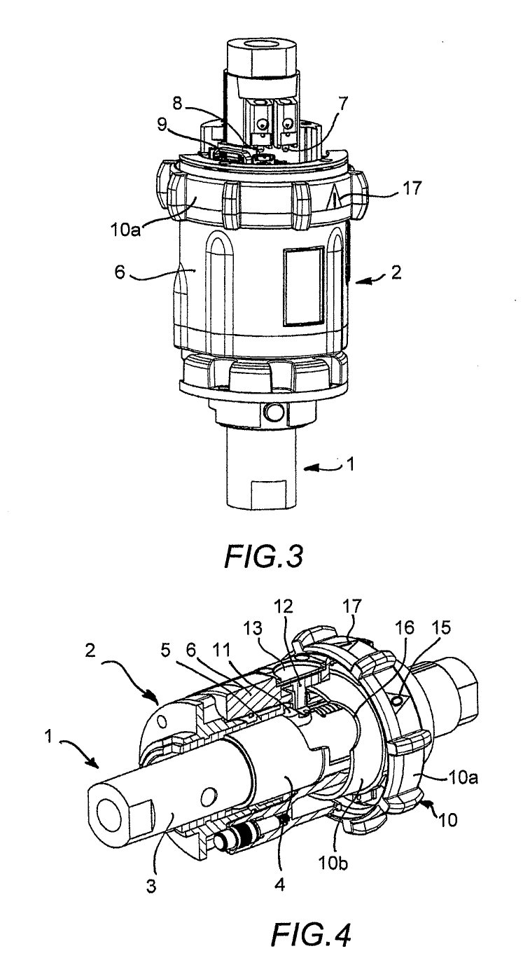

FIG. 3 corresponds to FIG. 2, with another view and without the sections of the casings of the plug and the base;

FIG. 4 corresponds to FIG. 2 after total coupling, the actuator having been manoeuvred into a position in which the pilot circuit is closed;

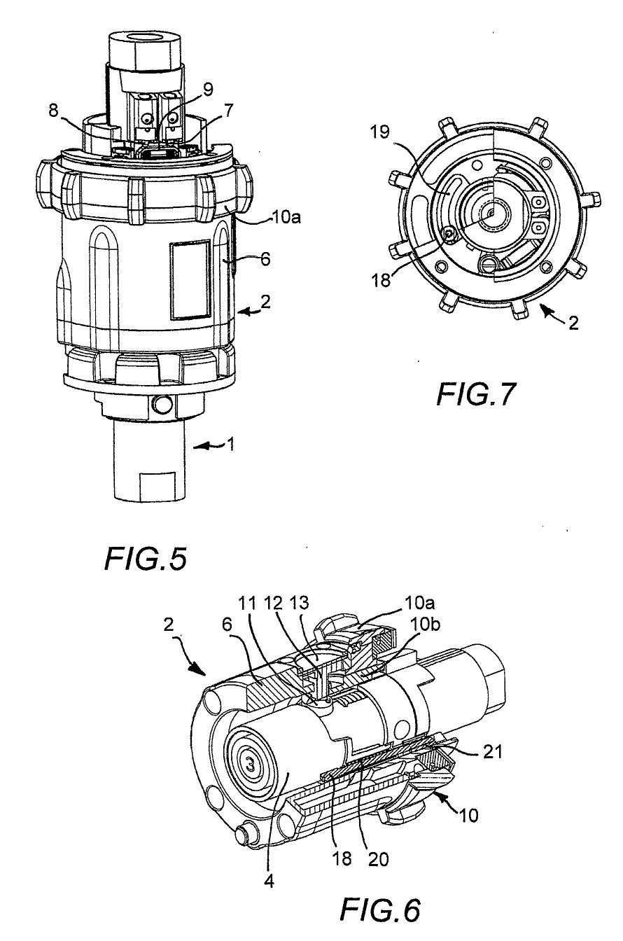

FIG. 5 corresponds to FIG. 4, with another view and without the sections of the casings of the plug and the base;

FIG. 6 shows the base in FIG. 1 in the same position but with another plane for the section of the outer casing and in addition with a section of the actuator;

FIG. 7 is an end view of the rear face of the base with a portion in section to show the interior.

The drawings show an electrical connection device formed of a base 1 and a plug 2 each provided with at least one power contact (not visible in the drawings). In the example shown, this is a single pole connection device, i.e. with a single power contact in the plug and the base (in the form for example of a tubular contact for the plug and a flexible blade for the base).

The contacts of the plug and the base are arranged in blocks 3 and 4 respectively of the plug and the base, which are surrounded by an outer casing 5 and 6 respectively.

The power to the power contact or contacts of the base is switched on by an apparatus not shown and which is controlled by a pilot circuit. The low power pilot circuit is designed for example to supply the coil of a contactor which opens or closes the power circuit supplying the base.

In the mode of embodiment shown, the pilot circuit is constituted here by two pilot contacts 7 and 8 arranged on the base and which can be seen in FIGS. 3 and 5.

The pilot contacts 7 and 8 form a circuit which can be closed by a shunt 9 in the form here of a simple strip. In FIG. 3, it can be seen that the pilot circuit is open, as the shunt 9 is not connecting the pilot contacts electrically, while in the position in FIG. 5 the pilot circuit is closed by the shunt 9, the actuation of the shunt being controlled by an actuator 10 which will be discussed in greater detail hereinafter.

The coupling of the plug in the base can be carried out by various manoeuvres which comprise here at least one movement of translation to pass from the position in FIG. 1 to the position in FIG. 2.

The plug and the base comprise matching means for locking in a connection position which here take the form of a hook 11 (FIGS. 1, 2, 4 and 6) arranged in the base and which is forced by an elastic means (not visible in the drawings) towards its locking position, said elastic means being for example a spring disposed under the hook.

The hook 11 can also be actuated by a button 12 locked to said hook towards its unlocking position against said elastic means mentioned previously.

Moreover in this example the button 12 is insulated from the exterior by a flexible membrane 13 (FIGS. 1, 2, 4, 6).

The matching locking means arranged on the plug here takes the form of a groove 14 formed at the end of the casing 5 of said plug.

When the plug is introduced into the casing 6 of the base, the front end of the casing 5 of the plug comes to bear on the hook 11 possibly provided for that purpose with an oblique portion forming a ramp such that said hook 11 engages entraining with it the button 12 as shown in FIG. 2 (however, it would also be possible to press the button 12 for this operation).

It can be seen that at the end of coupling, in the position in which the power contacts of the base and the plug are connected together, the hook 11 moves up into the groove 14, so locking the plug in the base as shown in FIG. 4.

The unlocking can then only be carried out by applying a pressure to the button 12.

The actuator 10 comprises a rotary actuating ring 10a and a skirt 10b locked to or forming a part of said ring which extends into the casing 6 of the base under a portion of the button 12, as shown clearly in FIGS. 1, 2, 4 and 6.

The ring 10a of the actuator is locked to the shunt 9 such that in the angular position of the latter shown in FIGS. 1, 2, 3 and 6, the pilot circuit 7, 8 is open as explained previously. To mark this position, a mark 15, for example the character “O”, marked on the ring 10a finds itself facing the button 12, as shown clearly in FIGS. 1 and 2.

The skirt 10b of the actuator 10 exhibits a notch 16, here in the form of a half circle, disposed in the position in FIGS. 1, 2, 3 and 6 just under the button 12, thus allowing freedom of movement to said button 12 in this position.

If the ring 10a of the actuator 10 is turned to adopt the position in FIGS. 4 and 5 so as to bring here a mark 17, for example the character “I” marked on said ring, just facing the button 12, the shunt 9 (FIG. 5) closes the pilot circuit 7, 8.

It can then be seen that in this position (FIGS. 4 and 5), the skirt 10b secures the button 12 which cannot be moved towards the unlocking position of the plug and the base.

Moreover, as shown clearly in FIGS. 6 and 7, a rod 18 is arranged in the base and passes through an opening 19 in the form of an arc of a circle (FIG. 7) formed in the actuator 10.

The rod 18 is forced by a spring 20 (FIG. 6) into a locking position in which a shoulder 21 prevents the rotation of the ring 10a by engaging in an appropriate housing of the actuator.

This rod 18 can be forced by the end section of the casing 5 of the plug against the spring 20 in order to unlock and allow the rotation of the ring 10a.

Following this description, the invention is easy to understand.

The plug 1 and the base 2 of the device initially appear in the position in FIGS. 1, 2, 3, 6 and 7.

In this position, the pilot circuit 7, 8 is open and the ring 10a is prevented from rotating by the rod 18 (FIG. 6) such that the power cannot be switched to the base since said pilot circuit can only be closed after having unlocked the ring 10a of the actuator by means of the plug 1.

However, this locking of the ring 10a is an additional security feature, as will be explained hereinafter.

After the coupling of the plug and the base (FIG. 2) until the two elements are locked by means of the hook 11 which engages in the groove 14 of the plug, it will be understood that the power contacts are connected together but that as the pilot circuit is open, the power is not switched on to the base.

At the end of the coupling operation, the rod 18 (FIG. 6) forced by the casing 5 of the plug, releases the ring 10a which can then be turned to close the pilot circuit as mentioned previously (FIGS. 4 and 5) and thus switch on the power to the base.

It will then be understood that the power contacts are connected together first before the power is switched on to the base.

In this position in which the power contacts are connected, with the power also switched on to the base (FIGS. 4 and 5), it can be seen that the skirt 10b of the actuator located under the button 12 prevents its actuation and thus any separation of the plug and the base due to the fact that the hook 11 cannot be disengaged from the groove 14 of the plug.

It is thus impossible to disconnect the plug and the base while the power is on, i.e. with the power switched on to the base.

To unlock the plug and the base it is firstly necessary to turn the ring 10a so that it returns to the position shown in FIGS. 1, 2, 3 and 6, the position in which the pilot circuit is open (and the power to the base is switched off) while the notch 16 allows the operation of the button 12 and thus the unlocking of the base and the plug.

Thus, the separation of the base and the plug requires two successive manual operations, namely: rotation of the ring of the actuator and operation of the locking button.

In the absence of the locking of the actuator 10 by the rod 18, it will be understood however that if the power is switched on to the base after rotation of the ring 10a, the skirt 10b prevents any operation of the button 12 and the hook 11 which remain in the locking position preventing any coupling of the plug and the base and hence any connection of the power contacts while the power is on.

The rod 18 which prevents the power being switched on to the base when the plug is not introduced into the base, also makes it possible to ensure that the power can only be switched on to the base if the plug is in the position in which the power contacts are completely connected.

Thus, the device according to the invention makes it impossible to connect and disconnect the power contacts when the power is switched on to the base.

1. Electrical connection device formed of an active base (2) and a plug (1) each provided with at least one power contact which are arranged so as to be connected together when the plug and said base are coupled in a connection position, pilot contacts (7, 8) of a pilot circuit being provided to control an apparatus for switching on or switching off the power to the power contacts of the base respectively through the closure and the opening respectively of said circuit, this closure and opening of the pilot circuit being obtained by means of an actuator (10) arranged on the base, while a device for locking and unlocking the plug in the base in a connection position is also provided and comprises matching locking means arranged on the plug and the base respectively, characterised in that the locking means of the base separate from the actuator (10) is mounted so that it is mobile and has at least one locking position and one unlocking position, the actuator (10) of the pilot circuit (7, 8) being arranged to secure said locking means for the base in its locking position when said pilot circuit (7, 8) is closed, and release the locking means when the pilot circuit is open, while the locking means for the base prevents any manoeuvre to couple the plug and the base or separate these once coupled, when said locking means is secured in its locking position by said actuator (10).

2. Electrical connection device according to claim 1, characterised in that the pilot circuit comprises two pilot contacts (7, 8) fixed on the base (2) and a shunt (9) mounted so as to rotate on the base, while the actuator (10) comprises a means which is locked in rotation to the shunt (9) and which has at least one position in which the two pilot contacts close the pilot circuit through contact with the shunt (9) and at least one position in which at least one of the pilot contacts is not in contact with the shunt, the pilot circuit then being open.

3. Electrical connection device according to claim 1, characterised in that the locking means for the base comprises a hook (11) which is mobile between a locking position and an unlocked position, and which is locked to an actuating button (12), and in that the locking means for the plug comprises a groove (14) designed to receive said hook (11) in the locking position obtained at the end of coupling of the plug and the base, while an elastic means is provided to force the hook (11) towards its locking position.

4. Electrical connection device according to claim 3, characterised in that said hook (11) exhibits an appropriate shape to be forced by a portion of the plug (1) in order to allow it to become lodged by elasticity in the groove (14) of said plug without it being necessary to operate the actuating button.

5. Electrical connection device according to claim 2, characterised in that the means of the actuator (10) locked in rotation to the shunt (9) is a rotary ring (10a) which is provided with a skirt (10b) passing under a portion of the actuating button (12) of the hook (11) to secure the latter in the locking position while a notch (16) is provided in said skirt (10b) to permit the mobility of said actuating button (12) towards the unlocked position of the hook (11), this notch being formed in a place in the skirt such that said notch is positioned under said actuating button when the ring (10a) is in a position in which the pilot circuit is open.

6. Electrical connection device according to claim 1, characterised in that a locking means for the actuator is also provided to secure the latter in its position in which the pilot circuit (7, 8) is open, while said locking means is arranged to be entrained into a releasing position by a portion of the plug (1) when the latter is in a connection position, such that the actuator (10) cannot be manoeuvred into its position in which the pilot circuit (7, 8) is closed until after the coupling of the plug in the base and connection of the power contact or contacts of the plug and the base.

7. Electrical connection device according to claim 6, characterised in that the actuator comprises a rotary ring (10a) and in that the locking means for said actuator takes the form of at least one moving rod (18) which is forced by an elastic means (20) towards its locking position in which said rod is introduced into a portion of the actuator to secure said ring in rotation while the rod can be entrained towards its releasing position by a portion of the end of the plug (1) in the course of its coupling with the base.

8. Electrical connection device according to claim 7, characterised in that the moving securing rod (18) passes through an opening (19) in the form of an arc of a circle formed in the actuator (10) and has a shoulder (21) designed to engage in an appropriate housing of the actuator to secure the latter such that the rod does not impede the rotation of the actuator when the shoulder (21) is outside said housing.
